(19) United States
(12) Patent Application Publication
(10) Pub. No.: US 2007/0079070 A1
(43) Pub. Date: Apr. 5, 2007

(54) Cache controller

(75) Inventors: Frederic Claude Marie Piry, Fleuris (FR); Philippe Jean-Pierre Raphalen, Valbonne (FR); Richard Roy Grisenthwaite, Guilden Morden (GB)

Correspondence Address: NIXON & VANDERHYE, PC, 901 NORTH GLEBE ROAD, 11TH FLOOR, ARLINGTON, VA, 22203, US

(73) Assignee: ARM Limited, Cambridge (GB)

(21) Appl. No.: 11/239,481

(22) Filed: Sep. 30, 2005

(51) Int. Cl. G06F 12/00

(52) U.S. Cl. 711/118

(57) ABSTRACT

A cache controller and a method is provided. The cache controller comprises: request reception logic operable to receive a write request from a data processing apparatus to write a data item to memory; and cache access logic operable to determine whether a caching policy associated with the write request is write allocate, whether the write request would cause a cache miss to occur, whether the write request is one of a number of write requests which together would cause greater than a predetermined number of sequential data items to be allocated in the cache and, if so, the cache access logic is further operable to override the caching policy associated with the write request to non-write allocate. In this way, in the event that the number of consecutive data items to be allocated within the cache exceeds the predefined number then the cache access logic will consider that it is highly likely that the write requests are associated with a block transfer operation and, accordingly, will override the write allocate caching policy. Accordingly, the write request will proceed but without the write allocate caching policy being applied. Hence, the pollution of the cache with these sequential data items is reduced.

### FIELD OF THE INVENTION

The present invention relates to a cache controller and a method.

### BACKGROUND OF THE INVENTION

Cache controllers are known and provide a mechanism for controlling accesses to a cache by a processor core or other data processing apparatus such as, for example, a co-processor or a direct memory access (DMA) engine.

As is known in the art, a cache is typically provided to provide an on-chip repository for data or instructions (referred to hereafter as a data item) to be used by a data processing apparatus. Typically, the cache will have a relatively small storage capacity in order to ensure low power consumption and to provide fast access times. When data items are requested by the data processing apparatus a request is initially made to the cache in order to determine whether the data item is accessible therein. In the event that the data item requested is not accessible then this data item will be retrieved from a higher-level memory and stored in the cache. Accesses to the higher-level memory are typically slower than those made to the cache. However, once the data item is stored in the cache then it may be rapidly accessed by the data processing apparatus thereafter.

It will be appreciated that since the size of the cache is finite there will come a time when it becomes full. Accordingly, many techniques exist to ensure that the cache stores those data items most likely to be accessed by the data processing apparatus. For example, different caching policies exist, such as write allocate and not write allocate (also often referred to as read allocate), which are used to determine if and when a data item is to be allocated to the cache when accessed by the data processing apparatus.

The read allocate caching policy requires that when a read request is made by the data processing apparatus and that read request results in a cache miss then the data item the subject of the read access is allocated to a suitable cache line within the cache.

The write allocate caching policy requires that when a write request is made to the cache and that write request results in a cache miss then the data item the subject of the write access is allocated to a suitable cache line within the cache.

In addition to these two caching policies there also exists a write back and write through caching policy, which are well known in the art.

It will be appreciated that in the event a request requires that a cache line be allocated but the cache is full then a decision has to be made in order to determine which of the currently allocated cache lines within the cache will need to be evicted to make room for that newly allocated cache line. Various techniques are well known in the art which enable this determination to be made, these include least recently used, first-in first out, etc.

Accordingly, by utilising the caching policies and by using appropriate line eviction techniques, a high probability of a cache hit occurring can be achieved which can improve the overall performance of the data processing apparatus.

However, situations can still occur whereby the performance of the cache is less than expected. Accordingly, it is desired to provide techniques which seek to alleviate these performance shortfalls.

### SUMMARY OF THE INVENTION

According to a first aspect, the present invention provides a cache controller comprising: request reception logic operable to receive a write request from a data processing apparatus to write a data item to memory; and cache access logic operable to determine whether a caching policy associated with the write request is write allocate, whether the write request would cause a cache miss to occur, whether the write request is one of a number of write requests which together would cause greater than a predetermined number of sequential data items to be allocated in the cache and, if so, the cache access logic is further operable to override the caching policy associated with the write request to non-write allocate.

The present invention recognises that in certain situations, the caching policy can create undesirable pollution of the cache. Cache pollution can be viewed as the allocation within the cache of data items which are unlikely to be subsequently required by the data processing apparatus, the allocation causing the eviction of data items which are likely to be subsequently required by the data processing apparatus. Such pollution can impact on the performance of the data processing apparatus since time and power is used in evicting data items which will subsequently need to be re-allocated within the cache.

For example, when operating with a write allocate caching policy, a situation can often arise whereby a software application needs to perform a particular operation on a region of memory. In particular, it may be necessary to transfer one region of memory to another or to store predetermined values in a region of memory (such as zeroing or initialising a region of memory). When such a block transfer operation occurs, and the caching policy for that region is write allocate, the cache will become polluted with this data and will rapidly fill. However, the present invention recognises that this operation not only fills the cache with data items which are unlikely to be used by the data processing apparatus thereafter, but also evicts those data items which may already reside in the cache and which are likely to be required by the data processing apparatus. Hence, time and power is used evicting the useful data from the cache and writing the polluting data to the cache and, thereafter, it is likely that time and power will be used evicting the polluting data from the cache and retrieving the evicted useful data back into the cache when the block transfer operation has completed and normal operation continues.

Accordingly, cache access logic is provided which determines whether the caching policy associated with a write request is set as write allocate and also determines whether a cache miss would occur for that write access. Furthermore, the cache access logic will review the write request and determine whether that write request is another in a sequence of write requests which will cause larger than a pre-programmed amount of sequential data items to be allocated within the cache.

The present invention recognises that a characteristic of a block transfer operation is that a large number of sequential or consecutive data items are the subject of write requests. Accordingly, in the event that the number of consecutive data items to be allocated within the cache exceeds the predefined number then the cache access logic will consider that it is highly likely that the write requests are associated with a block transfer operation and, accordingly, will override the write allocate caching policy. Accordingly, the write request will proceed but without the write allocate caching policy being applied. Hence, the pollution of the cache with these sequential data items is reduced.

In one embodiment, the cache access logic is operable to provide an indication of a number of sequential data items allocatable to the cache and, if the cache access logic determines, with reference to the indication, that allocating data items associated with the write request will cause greater than the predetermined number of sequential data items to be allocated in the cache then the cache access logic is further operable to override the caching policy associated with the write request to non-write allocate.

Hence, an indication is provided within the cache access logic of the number of sequential data items which are the subject of consecutive write requests and have been allocated or will be allocated to the cache. In this way, a simple comparison can then be made in order to determine whether the write request causes greater than the predetermined number of sequential data items to be allocated to the cache. Should this condition exist then the write allocate policy may be disabled.

In one embodiment, the cache access logic comprises a linefill buffer operable to store data items associated with each write request and to provide the indication.

Hence, in embodiments which utilise a linefill buffer, that linefill buffer may provide the indication of the number of consecutive data items to be allocated to the cache. It will be appreciated that by using a linefill buffer, even when each write request is not associated with strictly consecutive data items, should each of these write requests result in a data item being written to a particular location within the linefill buffer then it may be assumed that whilst the write requests themselves are not strongly ordered in overall terms, the write requests can still be considered to relate to sequential data items.

In one embodiment, the linefill buffer is operable to store a cache line of data items and, once full, to allocate the cache line of data items associated with write requests to the cache in accordance with the caching policy.

Hence, once the linefill buffer has been filled, the data is written in accordance with the currently selected caching policy. Accordingly, in the event that the number of sequential data items has not been exceeded then the data items in the linefill buffer will be written with the write allocate caching policy applied, whereas in the event that the number of sequential data items has been exceeded then the data items from the linefill buffer will be written with the write allocate caching policy being deactivated.

In one embodiment the linefill buffer is operable to store less than the predetermined number of sequential data items, the linefill buffer has a counter associated therewith and the linefill buffer is operable to update the counter each time the cache line of data items is allocated to the cache to provide the indication.

Accordingly, in the event that the size of the linefill buffer is less than that of the predetermined number of sequential data items then a counter is provided which is updated whenever the linefill buffer is emptied in order to provide a running total of the number of sequential data items which have been allocated.

In one embodiment, the predetermined number of sequential data items comprises at least three cache lines of data items.

Accordingly, in a typical arrangement, it is assumed that when more than three cache lines of sequential data items have been allocated then it is likely that a block memory transfer operation is occurring. Any consecutive write requests received thereafter are processed with the write allocate caching policy disabled. This ensures that the cache pollution is limited to just three cache lines and also provides an adequate performance balance by enabling other transactions associated with smaller number of sequential data items to complete with the write allocate caching policy applied since it is unlikely that such operations will result in wide spread cache pollution.

According to a second aspect of the present invention, there is provided a method of controlling data accesses to a cache, the method comprising the steps of: receiving a write request from a data processing apparatus to write a data item to memory; and determining whether a caching policy associated with the write request is write allocate, whether the write request would cause a cache miss to occur, whether the write request is one of a number of write requests which together would cause greater than a predetermined number of sequential data items to be written to the cache and, if so, overriding the caching policy associated with the write request to non-write allocate.

According to a third aspect of the present invention there is provided a cache controller comprising: request reception means for receiving a write request from a data processing apparatus to write a data item to memory; and cache access means for determining whether a caching policy associated with the write request is write allocate, for determining whether the write request would cause a cache miss to occur, for determining whether the write request is one of a number of write requests which together would cause greater than a predetermined number of sequential data items to be allocated in the cache and, if so, for overriding the caching policy associated with the write request to non-write allocate.

### BRIEF DESCRIPTION OF THE DRAWINGS

Embodiments of the present invention will now be described with reference to the accompanying drawings in which:

FIG. 1 illustrates a data processing apparatus incorporating a cache controller according to an embodiment of the present invention; and

FIG. 2 is a flow chart illustrating the operation of the data processing apparatus incorporating the cache controller.

### DESCRIPTION OF THE EMBODIMENTS

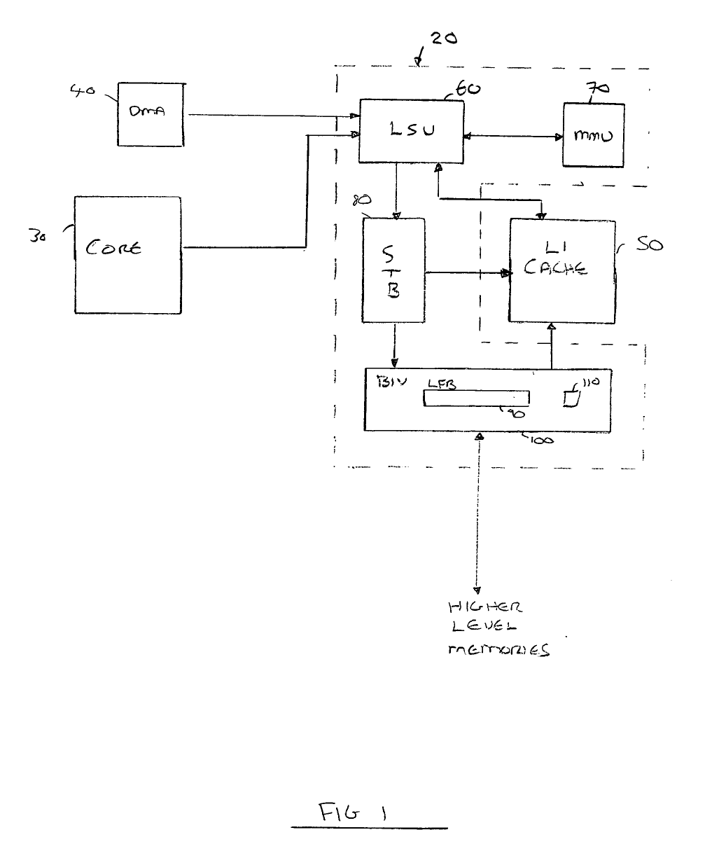

FIG. 1 illustrates a data processing apparatus, generally 10, incorporating a cache controller 20 according to an embodiment of the present invention. The data processing apparatus 10 comprises a core 30 coupled with the cache controller 20. Also coupled with the cache controller 20 is a direct memory access (DMA) engine 40. It will be appreciated that other master units such as, for example, a co-processor could also be coupled with the cache controller 20.

The cache controller 20 interfaces between the processor core 30 or the DMA engine 40 and a level one cache 50. Access requests from the core 30 or the DMA engine 40 are received by the cache controller 20. The cache controller 20 then processes the access request, in conjunction with the level one cache 50 or higher level memories (not shown).

Each access request is received by a load/store unit (LSU) 60 of the cache controller 20. The memory address of the access request is provided to a memory management unit (MMU) 70. The memory management unit 70 provides information which enables the load/store unit 60 to deal with the access request. In particular, the memory management unit 70 will typically translate any virtual address provided with the access requested into a physical address used by the memory system. Also, the memory management unit 70 will indicate whether data items associated with that address are cacheable or non-cacheable. Furthermore, the memory management unit 70 will indicate whether data items associated with that address fall within a memory region is write back or write through. Additionally, the memory management unit 70 will indicate whether the caching policy for that address is write allocate or not write allocate.

In the event that the data access is a read request then the load/store unit 60 will perform a look up using the level one cache 50.

In the event that a cache hit occurs then the load/store unit 60 will retrieve the data item from the level one cache 50 and return that data to the requesting master unit (e.g. the processor core 30 or the DMA engine 40).

In the event that a cache miss occurs then the load/store unit 60 will initiate a read from a higher level memory containing the requested data item. If the caching policy is set to read allocate then the retrieved data item will also be allocated within the level one cache 50 as well as being returned to the requesting unit. If the caching policy is set to non-cacheable then the retrieved data item will be retrieved from the higher level memory but not be allocated to the level one cache 50 and will instead be sent directly to the requesting unit.

In the event that the data access is a write access then the load/store unit 60 will forward details of the write access, together with the necessary information provided by the memory management unit 70 to a store buffer 80. The store buffer 80 will perform a look up using the level one cache 50.

In the event that a cache hit occurs then the write access is performed and the data item within the level one cache 50 is updated.

In the event that a cache miss occurs then the store buffer 80 will determine whether a write allocate caching policy applies to that write access. In the event that the write allocate caching policy does not apply to that write access then the store buffer 80 will forward the write request to a higher level memory and the data item in the higher level memory will be updated.

However, in the event that the write allocate policy is set for the write access and a cache miss occurs then the details of the write access are forwarded to a linefill buffer 90 within a bus interface unit 100. Because in this example the level one cache 50 is arranged to only allocate complete cache lines of data items, the linefill buffer 90 provides a temporary store which is used to hold individual data items which are the subject of a write access. The linefill buffer 90 can also retrieve the remaining data items of that cache line from a higher, if required, prior to storing that cache line in the level one cache 50. Such linefill buffers are well known in the art.

It will be appreciated that the rate at which write accesses can be issued by, for example, the processor core 30 or the DMA engine 40 will be significantly faster than the rate at which the linefill buffer 90 can retrieve any missing data items for that cache line from higher level memories. The linefill buffer 90 is able to detect when consecutive write accesses all fall within the same cache line. Hence, when that condition is detected, the linefill buffer 90 will wait before issuing any request to higher level memories for the data items since it is likely (when consecutive write accesses all fall within the same cache line) that an operation is being performed in which a whole cache line will be written by the core 30 or the DMA engine 40. If a whole cache line is being written then there is clearly no need to issue any request to higher level memories for missing data items since it is likely that these will be provided by the processor core 30 of the DMA engine 40 in due course. Accordingly, once the linefill buffer 90 is full, the cache line contained in the linefill buffer 90 will be written in accordance with the current caching policy.

In this embodiment, a single complete cache line is not sufficient to indicate that a block transfer operation is being performed and so when the cache line contained in the linefill buffer 90 is allocated to the level one cache 50 a counter within override logic 110 is incremented. Should the subsequent write accesses handled by the linefill buffer 90 also completely fill the linefill buffer 90 with sequential data items then the contents of the linefill buffer 90 will also be allocated to the level one cache 50 and the counter within the over ride logic 110 incremented once more.

This process continues until either the linefill buffer 90 is not completely filled with write accesses from the originating unit and data needs to be retrieved from a higher level memory (in which case the counter within the over ride logic 110 is reset), or the counter exceeds a predetermined value. When the counter exceeds that predetermined value then the override logic 110 overrides the write allocate policy associated with that cache line of data items to prevent that cache line from being allocated within the level one cache 50.

In a typical arrangement, the predetermined number of cache lines of sequential data items which may be allocated to the level one cache 50 is three, with subsequent cache lines of sequential data items having the write allocate policy overridden. However, the number of sequential data items which can be allocated prior to the override logic activating will vary depending upon the particular implementation but can be readily determined by examining the likely behaviour of the data processing apparatus in response to the typical types of instructions which it may receive. In this way, those write accesses which are likely to result from a block transfer operation may be overridden in order to prevent cache pollution. In this way, other legitimate write accesses which are unlikely to cause cache pollution can be allowed to be performed. Accordingly, it will be appreciated that it is the total number of sequential data items the subject of write accesses which is important, rather than the particular number of cache lines allocated. Hence, in arrangements where the length of the linefill buffer 90 is significantly less than the number of sequential data items likely to cause cache pollution then the number of allocations made by the linefill buffer 90 will be higher. Conversely, where the length of the linefill buffer 90 is longer, the number of cache lines allocated by that linefill buffer 90 prior to the override logic 110 activating may need to be less. Also, arrangements may exist where more than one linefill buffer 90 is provided and so the counter may need to maintain an indication for all of those linefill buffers. In arrangements which do not utilise a linefill buffer, it will be appreciated that alternative techniques may be used to determine when the predetermined number of sequential data items have been exceeded. Accordingly, the number of sequential data items which cause the override logic 110 to activate will be set to that which would rarely occur other than during a block transfer operation.

As mentioned previously, such block transfer operations will typically occur when an application is initiated or terminated. For example, during the initiation of an application, the data and instructions associated with that application may need to be transferred from one memory region to another. Such a transfer is generally administrative and does not result in the provision of any useful data. Hence, if the transfer is allowed to proceed then the cache may become polluted with that data. Also, it is often the case that when an application is first initialised then a region of memory is written with a predetermined value in order to ensure that no erroneous data items exist in that memory region. For example, it is often required to “zero” a page or region of data items in memory. It will be appreciated that such “zeroing” may, in addition to setting all the data items in those memory pages or regions to the value “0” also set these data items to any other predetermined value or sequence of values. It will also be appreciated that if during such zeroing, write allocation was allowed then the level one cache 50 will become full of zeros and any useful data will have been evicted.

It will be appreciated that every write access need not necessarily be individually sequential with each other, such as would occur in an out of order system. Instead, the linefill buffer 90 may be filled non-sequentially. However, it will be appreciated that from a higher level system perspective the write accesses can still be considered to be sequential even though their individual execution may be out of order. Similarly, it is not necessary that every cache line within the linefill buffer 90 is sequential with the previous cache line. Instead, it is simply sufficient to notice that the complete cache line has been filled without needing to access a higher level memory to obtain any missing data items in order to provide a suitable indication that sequential data accesses are occurring.

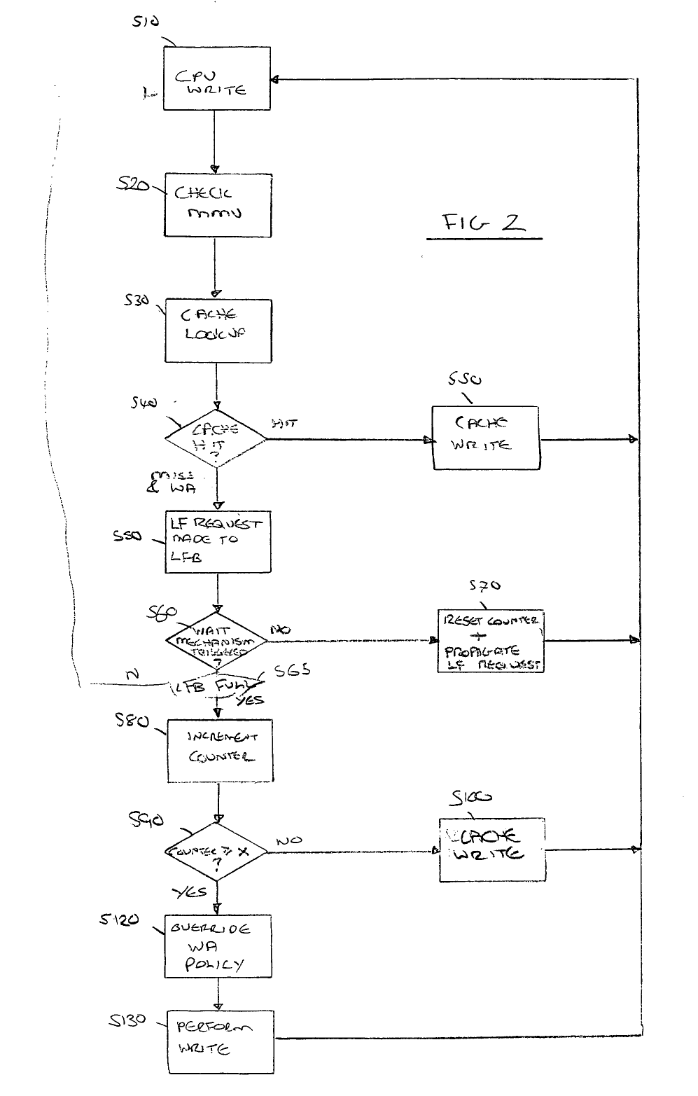

FIG. 2 illustrates in more detail the operation of the cache controller 20.

At step S10, a write access is received from the core 30.

At step S20, the load/store unit 60 interrogates the memory management unit 70 to obtain information associated with the memory address of the write access.

At step S30, the store buffer 80 performs a cache look up in the level one cache 50.

At step S40, it is determined whether a cache hit occurs or not.

In the event that a cache hit occurs then at step S50, the store buffer 80 updates the level one cache 50 with the updated data item. Thereafter, processing returns to step S10 to await the next write access.

In the event that it is determined at step S40, that a cache miss occurs and a write allocate policy has been indicated by the memory management unit 70 for that write access, then at step S50, a line fill request is made to the linefill buffer 90.

At step S60, the linefill buffer 90 determines whether the received write access is another write access within the same cache line as the preceding write access.

In the event that it is determined that the write access is not within the same cache line as the preceding write access then, at step S70, the counter within the override logic 110 is reset and the linefill buffer 90 will propagate the linefill request to the higher level memory. Once the higher level memory returns the missing data items from that cache line, the complete cache line is allocated to the level one cache 50.

Should the linefill buffer 90 determine at step S60 that the write access is another within the same cache line as the preceding write access then the wait mechanism is triggered to prevent a linefill request being propagated to the higher level memory.

At step S65, the linefill buffer 90 determines whether it is full (i.e. a complete cache line is stored therein).

In the event that the linefill buffer 90 is not full, processing returns to step S10 to await the next write access.

In the event that the linefill buffer 90 is full, processing proceeds to step S80 where the counter within the override logic 110 is incremented.

At step S90, a determination is made as to whether the counter has a value greater than or equal to the predetermined value, in this example, 3.

Should the counter not exceed the predetermined number then, at step S100, the cache line is allocated. Thereafter, processing returns to step S10.

In the event that the counter exceeds the predetermined value, then at step 120, the override logic 110 will override the write allocation policy.

Thereafter, at step S130, the write access will occur with the write allocation policy disabled. Accordingly, it will be appreciated that when greater than a particular number of sequential data items have been the subject of write accesses then those subsequent write accesses will be prevented from being allocated within the level one cache 50, thereby preventing pollution of that cache.

Accordingly, it will be appreciated that when using the present technique the need to take measures to prevent cache pollution when linear write accesses occur (which would typically be performed through complex software control) is removed and, instead, the detection of such linear write accesses can be made automatically and the appropriate ameliorative action to prevent cache pollution can take place in the hardware.

Although a particular embodiment of the invention has been described herewith, it will be apparent that the invention is not limited thereto, and that many modifications and additions may be made within the scope of the invention. For example, various combinations of the features from the following dependent claims could be made with features of the independent claims without departing from the scope of the present invention.

We claim:

1. A cache controller comprising:
request reception logic operable to receive a write request from a data processing apparatus to write a data item to memory; and
cache access logic operable to determine
whether a caching policy associated with said write request is write allocate,
whether said write request would cause a cache miss to occur,
whether said write request is one of a number of write requests which together would cause greater than a predetermined number of sequential data items to be allocated in said cache and, if so, said cache access logic is further operable to override said caching policy associated with said write request to non-write allocate.

2. The cache controller as claimed in claim 1, wherein said cache access logic is operable to provide an indication of a number of sequential data items allocatable to said cache and, if said cache access logic determines, with reference to said indication, that allocating data items associated with said write request will cause greater than said predetermined number of sequential data items to be allocated in said cache then said cache access logic is further operable to override said caching policy associated with said write request to non-write allocate.

3. The cache controller as claimed in claim 2, wherein said cache access logic comprises a linefill buffer operable to store data items associated with each write request and to provide said indication.

4. The cache controller as claimed in claim 3, wherein said linefill buffer is operable to store a cache line of data items and, once full, to allocate said cache line of data items associated with write requests to said cache in accordance with said caching policy.

5. The cache controller as claimed in claim 4, wherein said linefill buffer is operable to store less than said predetermined number of sequential data items, said linefill buffer has a counter associated therewith and said linefill buffer is operable to update said counter each time said cache line of data items is allocated to said cache to provide said indication.

6. The cache controller as claimed in claim 1, wherein said predetermined number of sequential data items comprises at least three cache lines of data items.

7. A method of controlling data accesses to a cache, said method comprising the steps of:
receiving a write request from a data processing apparatus to write a data item to memory; and
determining
whether a caching policy associated with said write request is write allocate,
whether said write request would cause a cache miss to occur,
whether said write request is one of a number of write requests which together would cause greater than a predetermined number of sequential data items to be written to said cache and, if so,
overriding said caching policy associated with said write request to non-write allocate.

8. The method as claimed in claim 7, further comprising the step of:
providing an indication a number of sequential data items to be written to said cache and said step of determining whether said write request is one of said number of write requests which together would cause greater than said predetermined number of sequential data items to be written to said cache comprises determining, with reference to said indication, whether writing data items associated with said write request will cause greater than said predetermined number of sequential data items to be written to said cache.

9. The method as claimed in claim 8, wherein said step providing said indication said number of sequential data items to be written to said cache comprises storing data items associated with each write request in a linefill buffer.

10. The method as claimed in claim 9, further comprising the step of writing, once said linefill buffer stores a cache line of data items, said cache line of data items associated with write requests to said cache in accordance with said caching policy.

11. The method as claimed in claim 10, wherein said linefill buffer is operable to store less than said predetermined number of sequential data items, said linefill buffer has a counter associated therewith and said linefill buffer is operable to update said counter each time said cache line of data items are written to said cache to provide said indication.

12. The method as claimed in claim 7, wherein predetermined number of sequential data items comprises at least three cache lines of data items.

13. A cache controller comprising:
request reception means for receiving a write request from a data processing apparatus to write a data item to memory; and
cache access means for determining whether a caching policy associated with said write request is write allocate, for determining whether said write request would cause a cache miss to occur, for determining whether said write request is one of a number of write requests which together would cause greater than a predetermined number of sequential data items to be allocated in said cache and, if so, for overriding said caching policy associated with said write request to non-write allocate.
